(19) United States
(12) Patent Application Publication
(10) Pub. No.: US 2007/0039184 A1
(43) Pub. Date: Feb. 22, 2007

(54) Apparatus for manufacturing and/or treating a material web, in particular a paper or board web

(76) Inventor: Diethelm Beisiegel, Gerstetten (DE)

Correspondence Address: TAYLOR & AUST, P.C., 142 SOUTH MAIN STREET, P. O. BOX 560, AVILLA, IN, 46710, US

(21) Appl. No.: 11/498,003

(22) Filed: Aug. 2, 2006

(30) Foreign Application Priority Data
Aug. 5, 2005 (DE) DE 102005037647.9

(51) Int. Cl. B23P 11/02; B23P 19/02

(52) U.S. Cl. 29/898; 29/446; 29/525; 29/724

(57) ABSTRACT

An apparatus for manufacturing and/or treating a material web, in particular a paper or board web, having a roll with bearing journals which are provided at the ends, a roll frame having bearings, in which the roll is mounted with its bearing journals so as to be rotatable about its longitudinal axis, and having a motor which is plugged onto a bearing journal and is carried by the bearing journal, the motor being clamped with respect to the bearing journal in order to avoid roundness and vibration problems, the clamping length being at least one tenth of the length of the motor shaft. The invention also relates to a method for attaching a drive motor to a roll or for retrofitting the drive motor.

### BACKGROUND OF THE INVENTION

1. Field of the Invention

The present invention relates to an apparatus for manufacturing and/or treating a material web, in particular a paper or board web, having a roll with bearing journals which are provided at the ends, a roll frame having bearings, in which the roll is mounted with its bearing journals so as to be rotatable about its longitudinal axis, and having a motor which is plugged onto a bearing journal.

2. Description of the Related Art

Rolls having plug-on motors are known. Here, the motor is usually configured as a hollow-shaft motor and is arranged on the bearing journal of the roll. A drive system of this type has, in particular, the advantage of a compact design. On the other hand, these systems have the disadvantage that the play which is necessary for assembly between the motor hollow shaft and the bearing journal of the roll widens during the course of operation, with the result that roundness and vibration problems can occur. The attempt to compensate for the assembly play by a clamping unit designed in the known manner has not proven successful for long-term disruption-free operation. The abovementioned problems also occurred here after only a short operating time.

### SUMMARY OF THE INVENTION

The invention provides an apparatus of the type which is mentioned above, which apparatus firstly maintains the possibility of a compact design but secondly does not have the above-mentioned problems.

This is achieved in that the motor is clamped with respect to the bearing journal, the clamping length being at least one tenth of the length of the motor shaft.

According to the invention, it has been recognized that the problems which are depicted above can be avoided if the clamping length between the motor and the bearing journal has a defined minimum length, namely at least one tenth of the length of the motor shaft. The compact design of plug-on motors can be maintained with an arrangement of this type, without roundness or vibration problems occurring.

The minimum clamping length is preferably 1.5 tenths of the length of the motor shaft, particularly preferably two tenths of the said length. It has been possible to achieve very satisfactory results with this, with regard to roundness and vibration properties.

According to the invention, in arrangements of conventional rolls of paper machines and customary plug-on motors, the minimum clamping length is then 20 mm, preferably 30 mm and more preferably 40 mm. It has also been possible to achieve the advantages which are depicted above with this.

If a plurality of pressing faces are provided, the abovementioned minimum clamping lengths are preferably valid for each of these pressing faces. In this way, it can be ensured that roundness or vibration problems do not occur on any of the pressing faces.

According to one refinement of the invention, the motor is attached to the roll in what is known as a cantilever arrangement. The plug-on motor is seated at the end on the bearing journal of the roll. In an arrangement of this type, assembly or dismantling is particularly simple, in particular in the case of retrofitting or conversion.

According to another refinement of the invention, the motor is arranged on the bearing journal between the roll and the roll bearing. This results in a particularly stable arrangement and the possibility of a large clamping length in the interior of the plug-on motor.

In the depicted cantilever arrangement of the plug-on motor, an adapter flange is preferably provided between the motor and the bearing journal. A plug-on motor having almost any desired journal geometry can be used by the use of an adapter. The motor does not itself have to be adapted to the journal geometry, as a result of which only low costs are produced. Moreover, a relatively short journal length is sufficient to provide a plug-on motor. Standard motor sizes can therefore also be used.

In the case of the use of an adapter flange, the minimum clamping length is preferably present between the adapter flange and the bearing journal of the roll. The production of the clamping connection is particularly simple on account of the adapter flange which is small in relation to the motor.

The adapter flange can be arranged outside the motor or engage into the hollow shaft of the motor. The first mentioned arrangement is particularly simple and inexpensive, while the second arrangement makes a particularly large clamping length possible with a smaller overall size.

In particular, in the case of the cantilever arrangement of the plug-on motor and in particular in the use of an adapter flange, the clamping face is preferably formed by a press fit. A pressing action of this type can be carried out simply and can also be used inexpensively in the case of retrofitting or conversion.

According to a further refinement of the invention, the clamping face is formed by a clamping element. As a result of this refinement, particularly great clamping forces and therefore particularly stable mounting of the plug-on motor can be achieved.

The clamping element can be actuated mechanically. The clamping element is then preferably configured as an annular clamping element. Here, it is advantageous if the clamping ring can be actuated from that side of the plug-on motor which faces away from the roll.

In one special refinement of the annular clamping element, the latter has a slotted taper sleeve and a slotted taper ring which surrounds the sleeve, which can be clamped axially against one another. As a result of being clamped axially against one another, the slotted taper ring is widened and pressed against the hollow shaft of the motor, while the taper sleeve is pressed radially inwards onto the bearing journal of the shaft. This produces a particularly stable connection between the bearing journal and the hollow shaft of the plug-on motor.

A spacer ring which prevents displacement of the motor with respect to the bearing journal during clamping is preferably arranged between the taper sleeve and the hollow shaft of the plug-on motor. This makes it possible to ensure correct seating of the motor on the bearing journal in a simple manner.

According to a further refinement of the invention, the clamping element can be actuated hydraulically. As a result, particularly high clamping forces can be applied.

In particular, the clamping element can be configured as a releasable hydraulic press-fit connection. The clamping element can therefore be used as required. Here, the configuration of the press-fit connection as a taper press-fit connection has proven particularly suitable.

In particular, an electric asynchronous motor is suitable as a plug-on motor. However, other electric motors can also advantageously be used, such as an electric synchronous motor having a permanent magnet.

The invention also relates to a method for attaching a drive motor to a roll of a paper machine or for converting or retrofitting the drive of the roll.

According to the invention, the motor is clamped with respect to the bearing journal of the roll during attachment or retrofitting, at least one tenth of the length of the motor shaft being selected as the clamping length. Here, the bearing journal substantially carries the weight of the motor. The clamping length is selected in such a way that it is at least one tenth of the length of the motor shaft. In the case of defined motor sizes or power outputs, clamping lengths of 1.5 tenths of the length or, as an alternative, two tenths of the motor length are selected.

It is very advantageous, in particular in retrofitting, if the motor is attached in a cantilever arrangement. An adapter flange is attached between the motor and the bearing journal. Here, a press-fit connection or a press fit (for example, K7/m6) is realized, as a result of which only a very short bearing journal is necessary. Moreover, the journal geometry can be selected as desired. The motor itself does not have to be adapted to the journal geometry, as a result of which standard motor sizes can be used for retrofitting or conversion.

It is also very advantageous if the motor is connected to the frame of the paper machine on a torque support.

Above all, the particular advantage of the solution according to the invention consists in that the roll can remain in the machine or machine frame during conversion or retrofitting and does not have to be dismantled.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a detail of a first variant of an apparatus according to the invention, in a partial section,

FIG. 2 shows a corresponding detail of a second variant of an apparatus according to the invention,

FIG. 3 shows a corresponding detail of a third variant of the apparatus according to the invention, and

FIG. 4 shows a partial sectional illustration of an annular clamping element according to the invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

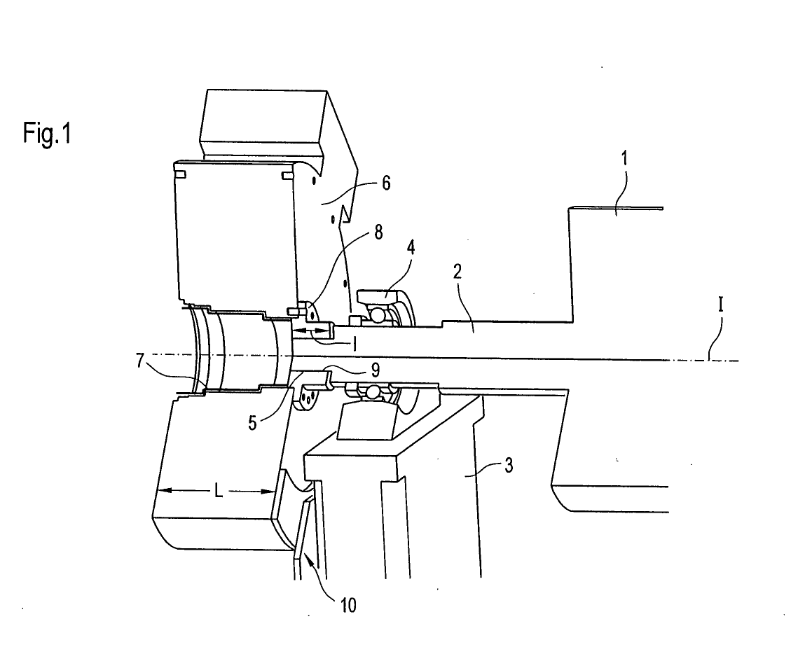

The apparatus which is shown in FIG. 1 includes a roll 1, in particular of a paper machine, which has a bearing journal 2 at one end, via which bearing journal 2 the roll 1 is mounted in a bearing 4 which is carried by a roll frame 3. Bearing journal 2 has an end section 5 of reduced diameter which protrudes beyond bearing 4 on the side which faces away from roll 1. A drive motor 6 for driving roll 1 rotationally in the manner which is described below is plugged onto this end section 5. Roll 1 can be rotated about its longitudinal axis I via motor 6.

Drive motor 6 has a hollow shaft 7, to which an adapter flange 8 is fastened such that it points towards roll 1 on the end side. Adapter flange 8 has a central passage opening 9, the diameter of which is selected in such a way that adapter flange 8 is fastened with a press fit on end section 5 of bearing journal 2. Moreover, motor 6 is supported fixedly in terms of rotation with respect to roll frame 3 via a torque support 10. However, the weight of motor 6 is carried substantially by bearing journal 2. Motor 6 is therefore attached to roll 1 here in what is known as a cantilever arrangement. In particular, motor 6 is configured as an electric asynchronous motor.

The length of the adapter flange 8 and the length of section 5 of bearing journal 2 are selected in such a way that the pressing face which forms the press fit has a length l in the direction of the rotational axis I of roll 1 between adapter flange 8 and section 5 of bearing journal 2, which length l is selected in accordance with the desired minimum size of the clamping length. In particular, the clamping length l is at least one tenth, preferably at least 1.5 tenths, more preferably at least two tenths, of the length L of motor shaft 7. This results in reliable fastening of motor 6 to bearing journals 2 of shaft 1 with low or no roundness or vibration problems, even after relatively long operation. In conventional rolls 1 of paper machines and customary plug-on motors 6, the clamping length l is at least 20 mm, preferably at least 30 mm and more preferably at least 40 mm.

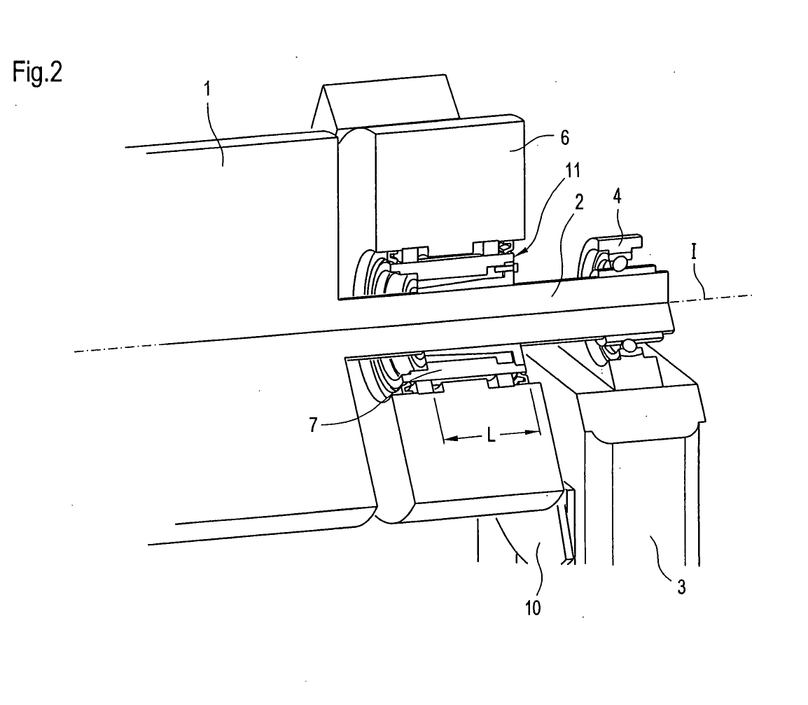

In the apparatus which is shown in FIG. 2, plug-on motor 6 is arranged on bearing journal 2 between roll 1 and bearing 4. Motor 6 is also supported fixedly in terms of rotation here with respect to roll frame 3 via a torque support 10, while the weight of motor 6 is carried substantially by bearing journal 2.

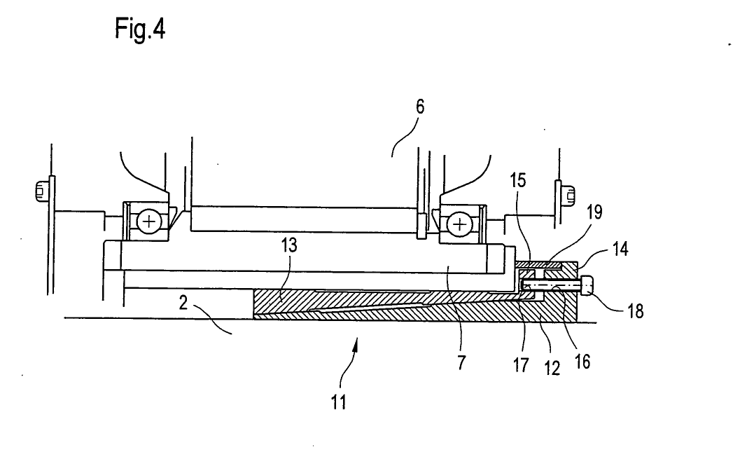

In this variant, hollow shaft 7 of plug-on motor 6 and bearing journal 2 are connected by a clamping element 11 which is arranged between bearing journal 2 and hollow shaft 7 of motor 6 and can be actuated from that side of motor 6 which faces away from roll 1. Clamping element 11 is formed by an annular clamping element, as is shown diagrammatically in FIG. 4. Annular clamping element 11 includes a slotted taper sleeve 12 which is surrounded by a likewise slotted taper ring 13. In each case on their side which faces away from roll 1, taper sleeve 12 and the taper ring 13 have an annular flange 14 and 15, respectively, passage openings 16 being provided in annular flanges 14 of taper sleeve 12 and threaded holes 17 being provided in annular flange 15 of taper ring 13. As shown, passage openings 16 and threaded holes 17 are aligned with one another, with the result that headed bolts 18 can be screwed into them.

As can be seen in FIG. 4, taper ring 13 is displaced axially in the direction of annular flange 14 of the taper sleeve by headed bolts 18 being screwed into threaded holes 17. Here, taper sleeve 13 is widened and is pressed against hollow shaft 7 of motor 6 on account of the tapering and slotted configuration of taper sleeve 12 and taper ring 13 and the diameters of both elements which are adapted to one another. At the same time, taper ring 12 is compressed as a result and is pressed against section 5 of bearing journal 2. In this way, a fixed connection is produced between hollow shaft 7 of motor 6 and bearing journal 2 of shaft 1.

The clamping length l which is determined by the length of taper ring 13 is particularly long, as can be seen in FIG. 4, and ensures stable fastening with no or permanently low roundness or vibration problems. Otherwise, a spacer ring 19 ensures during assembly of clamping element 11 that motor 6 is not displaced with respect to roll 1.

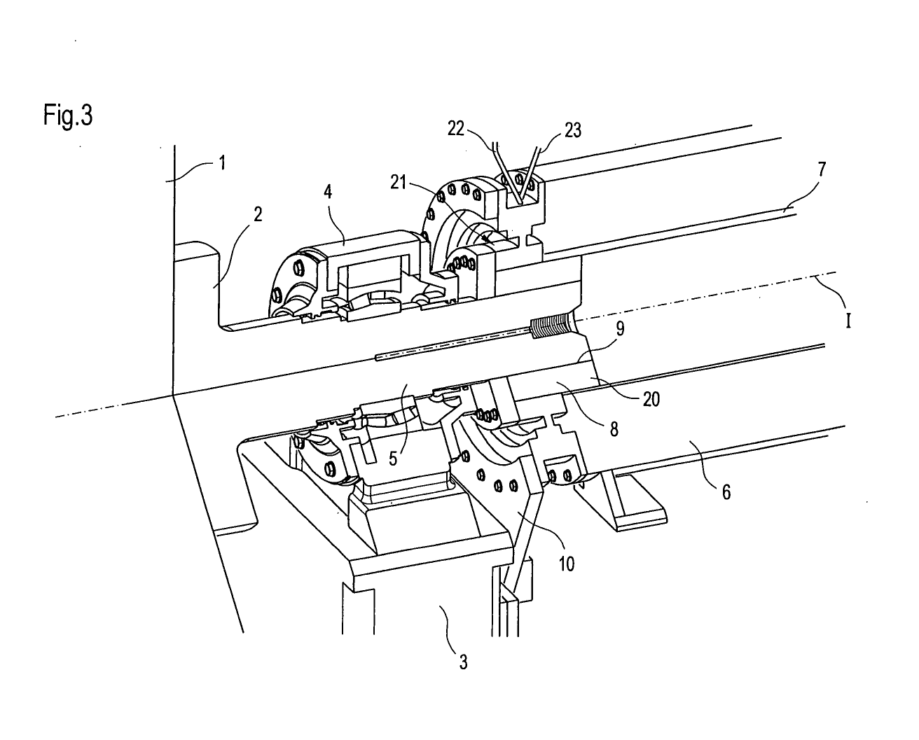

In the embodiment which is shown in FIG. 3, drive motor 6 is again connected to the end of bearing journal 2 of roll 1 in what is known as a cantilever arrangement. As in the exemplary embodiment of FIG. 1, an adapter flange 8 is provided here which, however, engages with an extended section 20 into hollow shaft 7 of motor 6.

In contrast to the embodiment of FIG. 1, adapter flange 8 in the variant of FIG. 3 is, moreover, not seated on bearing journal 2 with a press fit. Instead, adapter flange 8 is surrounded by a releasable hydraulic press-fit connection 21, to which pressure fluid can be supplied and from which pressure fluid can be removed via hydraulic lines 22 and 23. Adapter flange 8 which is connected fixedly to hollow shaft 7 on the end side is pressed onto bearing journal 2 of roll 1 by actuation of hydraulic press-fit connection 21.

As can be seen in FIG. 3, section 20 which engages into hollow shaft 7 of motor 6 results in a long clamping length l which in turn has the abovementioned minimum values. A taper press-fit connection designed in the known manner is used, in particular, as a hydraulic press-fit connection.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

1 Roll
2 Bearing journal
3 Roll frame
4 Bearing
5 Section of 2
6 Plug-on motor
7 Hollow shaft/motor shaft
8 Adapter flange
9 Passage opening
10 Torque support
11 Clamping element
12 Taper sleeve
13 Taper ring
14 Annular flange
15 Annular flange
16 Passage opening
17 Threaded hole
18 Headed bolt
19 Spacer ring
20 Section of 8
21 Hydraulic press-fit connection
22 Hydraulic line
23 Hydraulic line
I Rotational axis
L Length, motor shaft
l Clamping length

What is claimed is:

1. An apparatus for one of manufacturing and treating a fiber web, having a roll with opposite ends and bearing journals which are respectively provided at the ends, a roll frame having bearings, in which the roll is mounted using said bearing journals so as to be rotatable about a longitudinal axis, and having a motor which is plugged onto one said bearing journal, said motor including a hollow-shaft carried by said one bearing journal, said motor being clamped with respect to the bearing journal, the clamping length (l) being at least one tenth of a length (L) of the hollow shaft.

2. The apparatus according to claim 1, wherein the clamping length is at least 1.5 tenths of the length of the motor shaft.

3. The apparatus according to claim 1, wherein the clamping length is at least two tenths of the length of the motor shaft.

4. The apparatus according to claim 1, wherein the clamping length is at least 20 mm.

5. The apparatus according to claim 1, wherein the clamping length is at least 30 mm.

6. The apparatus according to claim 1, wherein the clamping length is at least 40 mm.

7. The apparatus according to claim 1, wherein, in the case of a plurality of existing clamping lengths (l), each clamping length has the minimum length.

8. The apparatus according to claim 1, wherein the motor is attached to the roll with a cantilever arrangement.

9. The apparatus according to claim 8, wherein an adapter flange is provided between the motor and the bearing journal.

10. The apparatus according to claim 9, wherein the adapter flange is arranged outside the motor.

11. The apparatus according to claim 9, wherein the adapter flange engages into the hollow shaft of the motor.

12. The apparatus according to claim 9, wherein the minimum clamping length (l) is present between the adapter flange and the bearing journal.

13. The apparatus according to one of claim 1, wherein the motor is arranged on the bearing journal between the roll and the bearing.

14. The apparatus according to claim 1, wherein a clamping face is formed by pressure clamping.

15. The apparatus according to claim 1, wherein a clamping face is formed by a clamping element.

16. The apparatus according to claim 15, wherein the clamping element can be actuated mechanically.

17. The apparatus according to claim 16, wherein the clamping element can be actuated from a side of the motor which faces away from the roll.

18. The apparatus according to claim 16, wherein the clamping element is configured as an annular clamping element.

19. The apparatus according to claim 18, wherein the annular clamping element has a slotted taper sleeve and a slotted taper ring which surrounds the sleeve, said slotted taper sleeve and said slotted taper ring being clamped axially against one another.

20. The apparatus according to claim 19, wherein a spacer ring which prevents displacement of the motor with respect to the bearing journal during clamping is arranged between the taper sleeve and the hollow shaft of the plug-on motor.

21. The apparatus according to claim 15, wherein the clamping element can be actuated hydraulically.

22. The apparatus according to claim 21, wherein the clamping element is configured as a releasable hydraulic press-fit connection.

23. The apparatus according to claim 22, wherein the press-fit connection is configured as a taper press-fit connection.

24. The apparatus according to claim 1, wherein the plug-on motor is configured as one of an electric asynchronous motor and an electric synchronous motor, either having a permanent magnet.

25. A method for one of attaching and retrofitting a drive motor to a roll of a machine for one of manufacturing and treating a fiber material web, the roll being mounted with bearing journals which are provided at the ends in a roll frame having bearings so as to be rotatable about a longitudinal axis, the roll being driven by the motor which is configured as a hollow-shaft motor, said method including the step of clamping the motor with respect to the bearing journal during attachment or retrofitting, at least one tenth of the length of the motor shaft being selected as a clamping length.

26. The method according to claim 25, wherein at least 1.5 tenths of the length of the motor shaft is selected as the clamping length.

27. The method according to claim 25, wherein at least two tenths of the length of the motor shaft is selected as the clamping length.

28. The method according to claim 25, wherein at least 20 mm is selected as the clamping length.

29. The method according to claim 25, wherein at least 30 mm is selected as the clamping length.

30. The method according to claim 25, wherein at least 40 mm is selected as the clamping length.

31. The method according to claim 25, wherein, in the case of a plurality of existing clamping lengths, each clamping length has the minimum length.

32. The method according to claim 25, wherein the motor is attached to the roll in a cantilever arrangement.

33. The method according to claim 32, wherein an adapter flange is installed between the motor and the bearing journal.

34. The method according to claim 33, wherein the adapter flange is attached outside the motor.

35. The method according to claim 34, wherein the adapter flange is attached to engage into the hollow shaft of the motor.

36. The method according to claim 33, wherein the installation is performed in such a way that a minimum clamping length is maintained between the adapter flange and the bearing journal.

37. The method according to claim 25, wherein the motor is attached to the bearing journal between the roll and the bearing.

38. The method according to claim 25, wherein a clamping face is formed by pressure clamping.

39. The method according to claim 25, wherein a clamping element is installed as a clamping face.

40. The method according to claim 39, wherein the clamping element is actuated one of mechanically and hydraulically and from a side of the motor which faces away from the roll.

41. The method according to claim 25, wherein a weight of the motor is absorbed substantially by the bearing journal and the motor is connected to the roll frame via a torque support.

42. The method according to claim 25, wherein an electric asynchronous motor is used as the motor.
